(19) United States
(12) Patent Application Publication
(10) Pub. No.: US 2023/0162024 A1
(43) Pub. Date: May 25, 2023

(54) TERNARY CONTENT ADDRESSABLE MEMORY (TCAM)-BASED TRAINING METHOD FOR GRAPH NEURAL NETWORK AND MEMORY DEVICE USING THE SAME

(71) Applicant: MACRONIX INTERNATIONAL CO., LTD., Hsinchu (TW)

(72) Inventors: Wei-Chen WANG, Taipei City (TW); Yu-Pang WANG, Taoyuan City (TW); Yuan-Hao CHANG, Taipei City (TW); Tei-Wei KUO, Taipei City (TW)

(21) Appl. No.: 17/686,478

(22) Filed: Mar. 4, 2022

Related U.S. Application Data
(60) Provisional application No. 63/282,696, filed on Nov. 24, 2021.
(60) Provisional application No. 63/282,698, filed on Nov. 24, 2021.

(51) Int. Cl. G06N 3/08; G06F 7/544

(52) U.S. Cl. CPC G06N 3/08; G06F 7/5443

(57) ABSTRACT

A Ternary Content Addressable Memory (TCAM)-based training method for graph neural network and a memory device using the same are provided. The TCAM-based training method for Graph Neural Network includes the following steps. Data are sampled from a dataset. The Graph Neural Network is trained according to the data from the dataset. The step of training the Graph Neural Network includes a feature extraction phase, an aggregation phase and an update phase. In the aggregation phase, one TCAM crossbar matrix stores a plurality of edges corresponding to one vertex and outputs a hit vector for selecting some of the edges, and a Multiply Accumulate (MAC) crossbar matrix stores a plurality of features in the edges for performing a multiply accumulate operation according to the hit vector.

This application claims the benefit of U.S. provisional application Ser. No. 63/282,696, filed Nov. 24, 2021, and U.S. provisional application Ser. No. 63/282,698, filed Nov. 24, 2021, the subject matters of which are incorporated herein by references.

### TECHNICAL FIELD

The disclosure relates in general to a training method for neural network and a memory device using the same, and more particularly to a Ternary Content Addressable Memory (TCAM)-based training method for graph neural network and a memory device using the same.

### BACKGROUND

In the development of Artificial intelligence (AI) technology, in-memory computing has applied for system-on-chip (SoC) designs. In-memory computing can speed up the training and the inference of the AI algorithm. Therefore, in-memory computing becomes an important research direction.

However, when training in the memory, huge data movement may cause a drop in speed. Researchers are working to improve the training efficiency of the in-memory computing.

### SUMMARY

The disclosure is directed to a Ternary Content Addressable Memory (TCAM)-based training method for graph neural network and a memory device using the same. In the TCAM-based training method, an adaptive data reusing policy is applied in the sampling step, and a TCAM-based data processing strategy and a dynamic fixed-point formatting approach are applied in an aggregation phase. The data movement can be greatly reduced and accuracy can be kept. The training efficiency of the in-memory computing, especially for the Graph Neural Network, is greatly improved.

According to one embodiment, a Ternary Content Addressable Memory (TCAM)-based training method for Graph Neural Network is provided. The TCAM-based training method for the Graph Neural Network includes the following steps. Data are sampled from a dataset. The Graph Neural Network is trained according to the data from the dataset. The step of training the Graph Neural Network includes a feature extraction phase, an aggregation phase and an update phase. In the aggregation phase, one TCAM crossbar matrix stores a plurality of edges corresponding to one vertex and outputs a hit vector for selecting some of the edges, and a Multiply Accumulate (MAC) crossbar matrix stores a plurality of features in the edges for performing a multiply accumulate operation according to the hit vector.

According to another embodiment, a memory device. The memory device includes a controller and a memory array. The memory array is connected to the controller. In the memory array, one Ternary Content Addressable Memory (TCAM) crossbar matrix stores a plurality of edges corresponding to one vertex and outputs a hit vector for selecting some of the edges, and a Multiply Accumulate (MAC) crossbar matrix stores a plurality of features in the edges for performing a multiply accumulate operation according to the hit vector.

### BRIEF DESCRIPTION OF THE DRAWINGS

FIG. 1 shows an example of a graph applied the Graph Neural Network.

FIG. 2 shows a flowchart of a TCAM-based training method for the Graph Neural Network according to one embodiment.

FIG. 3 shows an example for executing the step S110.

FIG. 4 illustrates a feature extraction phase, an aggregation phase and an update phase.

FIG. 5 shows a crossbar matrix.

FIG. 6 shows a TCAM crossbar matrix and a Multiply Accumulate (MAC) crossbar matrix.

FIGS. 7 to 10 illustrate the operation of the TCAM crossbar matrix and the MAC crossbar matrix.

FIGS. 11 to 13 illustrate the operation of the TCAM crossbar matrix and the MAC crossbar matrix for several batches.

FIG. 14 illustrates a pipeline operation in the TCAM-based data processing strategy.

FIG. 15 illustrates a dynamic fixed-point formatting approach.

FIG. 16 illustrates the bootstrapping approach.

FIG. 17 illustrates a graph partitioning approach.

FIG. 18 illustrates a non-uniform bootstrapping approach.

FIG. 19 shows a flowchart of an adaptive data reusing policy according to one embodiment.

FIG. 20 shows a memory device adopted the TCAM-based training method described above.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

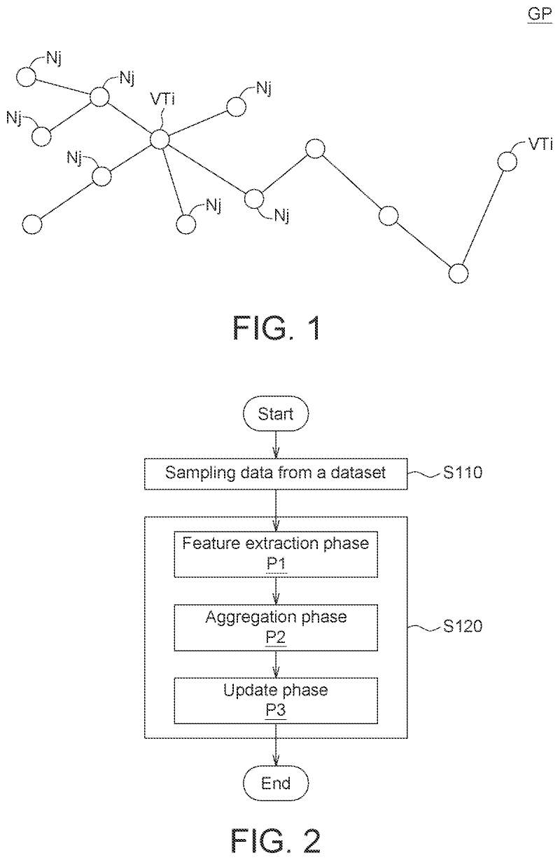

In the present embodiment, a Ternary Content Addressable Memory (TCAM)-based training method for Graph Neural Network is provided. Please refer to FIG. 1, which shows an example of a graph GP applied the Graph Neural Network. The graph GP may include several vertexes VTi and several nodes Nj. The vertexes VTi and the nodes Nj may be any person, any organization, or any department. The edges among the vertexes VTi and the nodes Nj store the features thereof. The Graph Neural Network may be used to make the inference of the relationship between two of the vertexes VTi.

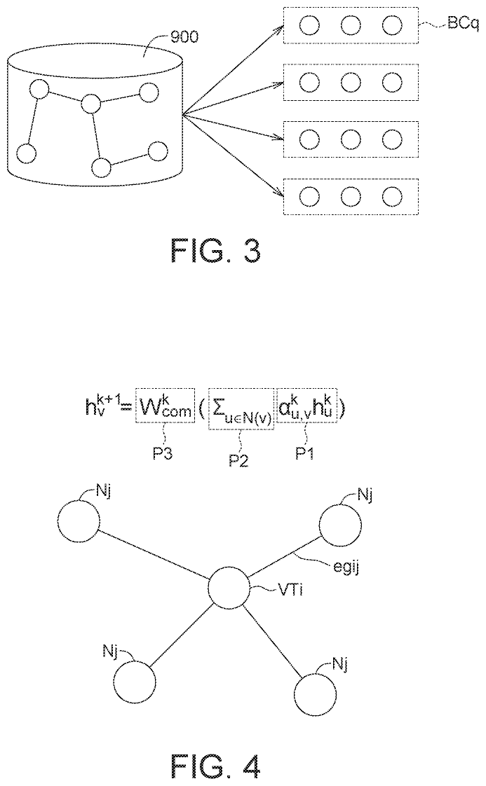

The TCAM-based training method can improve the training efficiency of the in-memory computing. Please refer to FIG. 2, which shows a flowchart of the TCAM-based training method for Graph Neural Network according to one embodiment. In step S110, sampling data from a dataset 900 is executed. Please refer FIG. 3, which shows an example for executing the step S110. In FIG. 3, several batches BCq will be performed the training step (the step S110) in several iterations.

In step S120, training the Graph Neural Network according to the data from the dataset 900 is executed. The step S120 includes a feature extraction phase P1, an aggregation phase P2 and an update phase P3. Please refer FIG. 4, which illustrates the feature extraction phase P1, the aggregation phase P2 and the update phase P3. In the feature extraction phase P1, features on the edges and the nodes, are extracted. In the aggregation phase P2, several computing, such as Multiply Accumulate is executed. In the update phase P3, weightings are updated. The aggregation phase P2 is an input/output-intensive task, and may incur huge data movement. The training performance bottleneck is occurred at the aggregation phase P2.

To improve the training efficiency, an adaptive data reusing policy is applied in the step S110 of sampling data from the dataset 900, and a TCAM-based data processing strategy and a dynamic fixed-point formatting approach are applied in the aggregation phase P2. The following illustrates the TCAM-based data processing strategy and the dynamic fixed-point formatting approach first, then illustrates the adaptive data reusing policy.

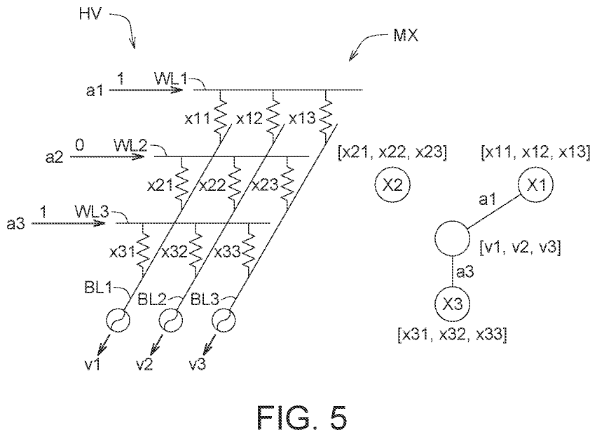

The TCAM-based data processing strategy applied in the aggregation phase P2 includes an intra-vertex parallelism architecture and an inter-vertex parallelism architecture. Please refer to FIG. 5, which shows a crossbar matrix MX. In the present embodiment, a plurality of features x11, x12, x13, x21, x22, x23, x31, x32, x33 can be stored in the crossbar matrix MX. The crossbar matrix MX is, for example, a Resistive random-access memory (ReRAM). The crossbar matrix MX includes a plurality of word lines WL1, WL2, WL3, a plurality of bit lines BT1, BT2, BT3 and a plurality of cells. The cells store the features x11, x12, x13, x21, x22, x23, x31, x32, x33, instead of weightings. In the aggregation phase P2, a plurality of coefficients a1, a2, a3 are inputted to the word lines WL1, WL2, WL3 and a plurality of multiply accumulate results v1, v2, v3 are obtained from the bit lines BL1, BT2, BT3. 0 or 1 can be used to select any of the nodes X1, X2, X3. As shown in FIG. 4, [1, 0, 1] is a hit vector HV used to select the nodes X1, X3.

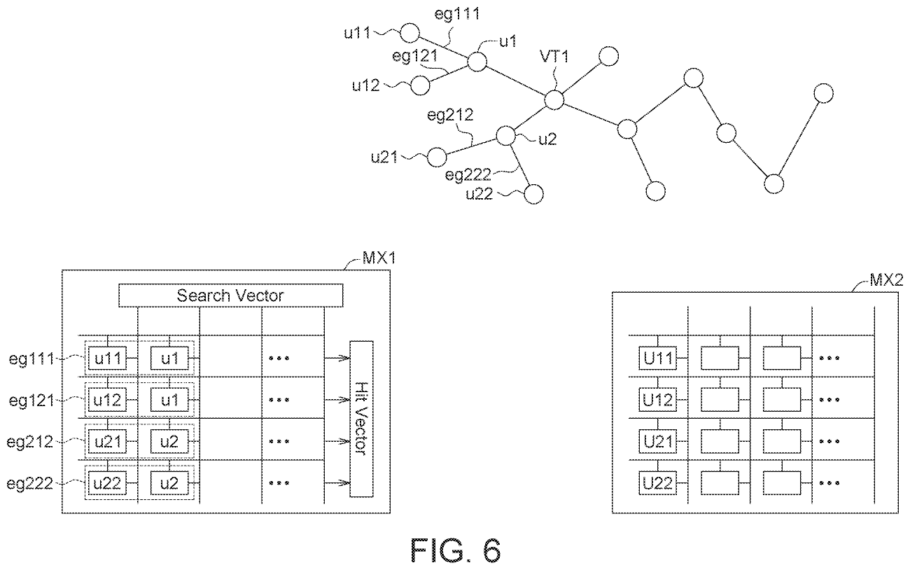

Please refer to FIG. 6, which shows a TCAM crossbar matrix MX1 and a Multiply Accumulate (MAC) crossbar matrix MX2. In the aggregation phase P2, the TCAM crossbar matrix MX1 stores a plurality of edges eg111, eg121, eg212, eg222, . . . corresponding to one vertex VT1 and outputs the hit vector HV for selecting some of the edges eg111, eg121, eg212, eg222, . . . . The edge eg111 includes the source node u11 and the destination node u1. The edge eg121 includes the source node u12 and the destination node u1. The edge eg212 includes the source node u21 and the destination node u2. The edge eg222 includes the source node u22 and the destination node u2.

The MAC crossbar matrix MX2 stores a plurality of features U11, U12, U21, U22, . . . in the edges eg111, eg121, eg212, eg222, . . . , for performing a multiply accumulate operation according to the hit vector HV under the intra-vertex parallelism architecture. Some examples are provided here via the following drawings.

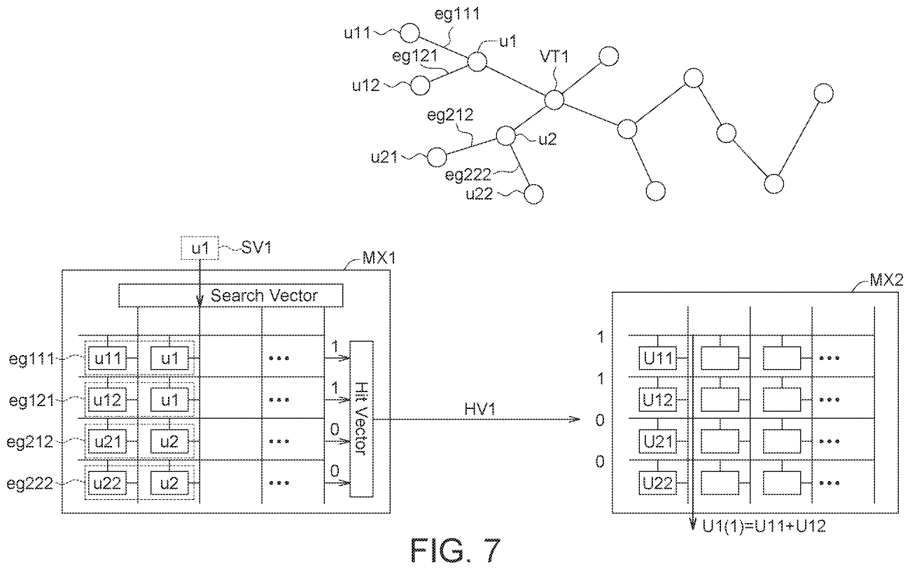

Please refer to FIGS. 7 to 10, which illustrate the operation of the TCAM crossbar matrix MX1 and the MAC crossbar matrix MX2. As shown in FIG. 7, a search vector SV1 is inputted to the TCAM crossbar matrix MX1. The content of the search vector SV1 is the destination node u1. The destination node u1 of the edge eg111 matches the search vector SV1, so 1 is outputted. The destination node u1 of the edge eg121 matches the search vector SV1, so 1 is outputted. The destination node u2 of the edge eg212 does not match the search vector SV1, so 0 is outputted. The destination node u2 of the edge eg222 does not match the search vector SV1, so 0 is outputted. Therefore, the hit vector HV1, which is “[1, 1, 0, 0]”, is outputted to the MAC crossbar matrix MX2.

The hit vector HV1 is inputted to the MAC crossbar matrix MX2 for selecting the features U11, U12. As shown in FIG. 7, a multiply accumulate result U1(1) is obtained (the multiply accumulate result U1(1)=the feature U11+the feature U12).

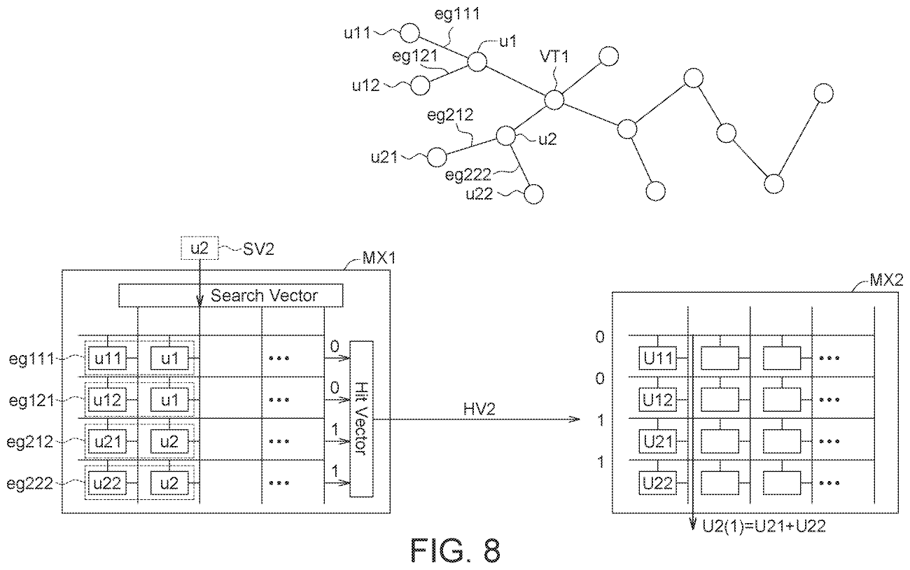

As shown in FIG. 8, a search vector SV2 is inputted to the TCAM crossbar matrix MX1. The content of the search vector SV2 is the destination node u2. The destination node u1 of the edge eg111 does not match the search vector SV2, so 0 is outputted. The destination node u1 of the edge eg121 does not match the search vector SV2, so 0 is outputted. The destination node u2 of the edge eg212 matches the search vector SV2, so 1 is outputted. The destination node u2 of the edge eg222 matches the search vector SV2, so 1 is outputted. Therefore, the hit vector HV2, which is “[0, 0, 1, 1]”, is outputted to the MAC crossbar matrix MX2.

The hit vector HV2 is inputted to the MAC crossbar matrix MX22 for selecting the features U21, U22. As shown in FIG. 8, a multiply accumulate result U2(1) is obtained (the multiply accumulate result U2(1)=the feature U21+the feature U22).

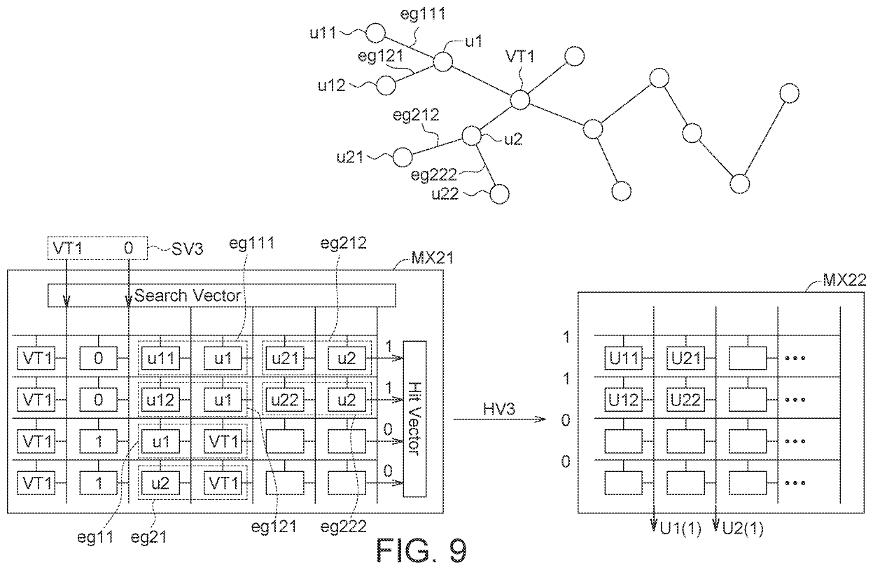

As shown in FIG. 9, a TCAM crossbar matrix MX21 may further store the vertex VT1, . . . , the layer L0, L1, . . . and the edges eg11, eg21. The edges eg111, eg121, eg212, eg222 are stored corresponding the vertex VT1 and the layer L0. The edges eg11, eg21 are stored corresponding to the vertex VT1 and the layer L1. The edges eg11, eg21 are stored corresponding to the vertex VT1 and the layer L1. A search vector SV3 is inputted to the TCAM crossbar matrix MX21. The content of the search vector SV3 is the vertex VT1 and the layer L0. The vertex VT1, the layer L0 and the edges eg111, eg212 corresponding thereto match the search vector SV3, so 1 is outputted. The vertex VT1, the layer L0, and the edges eg121, eg222 corresponding thereto match the search vector SV3, so 1 is outputted. The vertex VT1, the layer L1, and the edges eg11 corresponding thereto do not match the search vector SV3, so 0 is outputted. The vertex VT1, the layer 1, and the edges eg21 corresponding thereto do not match the search vector SV3, so 0 is outputted. Therefore, the hit vector HV3, which is “[1, 1, 0, 0]”, is outputted to the MAC crossbar matrix MX22.

The hit vector HV3 is inputted to the MAC crossbar matrix MX22 for selecting the features U11, U21 and selecting the features U12, U22. As shown in FIG. 9, the multiply accumulate results U1(1), U2(1) are obtained.

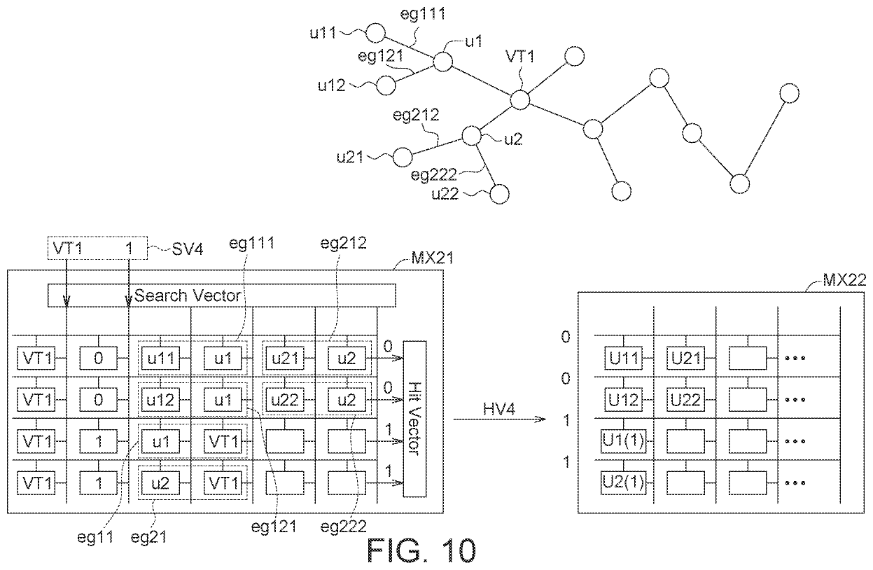

As shown in FIG. 10, the MAC crossbar matrix MX22 further stores the multiply accumulate results U1(1), U2(1) respectively corresponding to the edges eg11, eg21. A search vector SV4 is inputted to the TCAM crossbar matrix MX21. The content of the search vector SV4 is the vertex VT1 and the layer L1. The vertex VT1, the layer L0 and the edges eg111, eg212 corresponding thereto do not match the search vector SV4, so 0 is outputted. The vertex VT1, the layer L0, the edges eg121, eg222 corresponding thereto do not match the search vector SV4, so 0 is outputted. The vertex VT1, the layer L1 and the edges eg11 corresponding thereto match the search vector SV4, so 1 is outputted. The vertex VT1, the layer L1 and the edges eg21 corresponding thereto match the search vector SV4, so 1 is outputted. Therefore, the hit vector HV4, which is “[0, 0, 1, 1]”, is outputted to the MAC crossbar matrix MX22.

The hit vector HV4 is inputted to the MAC crossbar matrix MX22 for selecting the multiply accumulate result U1(1), U2(1). As shown in FIG. 10, a multiply accumulate result is obtained.

In one embodiment, the TCAM crossbar matrix MX21 may further store a plurality of edges corresponding to another one vertex under the inter-vertex parallelism architecture. The search vector can be used to select the particular vertex.

Base on above, in the inter-vertex parallelism architecture, the bank/matrix-level parallelism is utilized to aggregate different vertexes. And in the intra-vertex parallelism architecture, the column bandwidth of a crossbar matrix is efficiently utilized to disperse the computation of the aggregation.

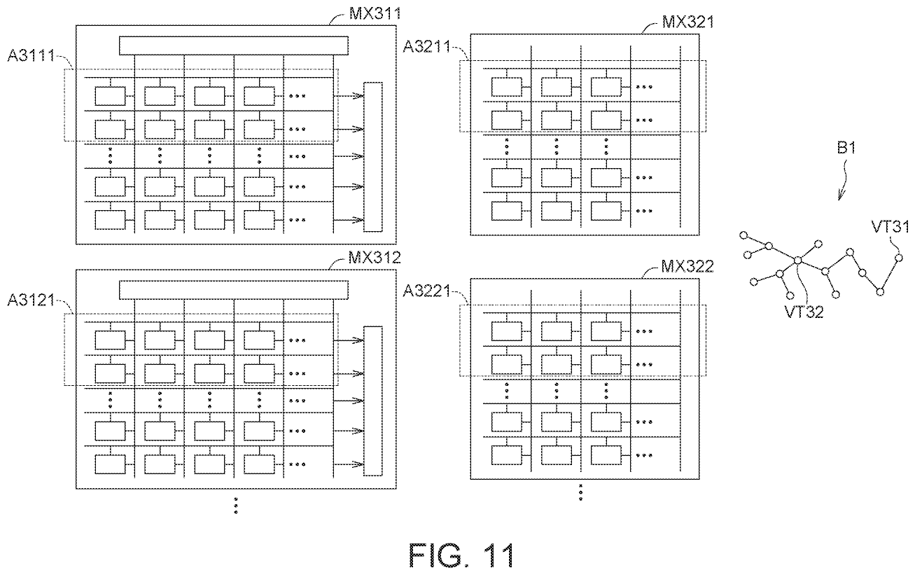

Please refer to FIGS. 11 to 13, which illustrate the operation of the TCAM crossbar matrix MX311, MX312, . . . and the MAC crossbar matrix MX321, MX322, . . . for several batches B1, B2, . . . , Bk. As shown in FIG. 11, several TCAM crossbar matrixes MX311, MX312, . . . and several MAC crossbar matrixes MX321, MX322, . . . are arranged in several memory banks. For the batch B1, the memory area A3111 is used to store the edge list of the vertex VT31, and the memory area A3211 is used to store the features of the vertex VT31. The memory area A3121 is used to store the edge list of the vertex VT32, and the memory area A3221 is used to store the features of the vertex VT32.

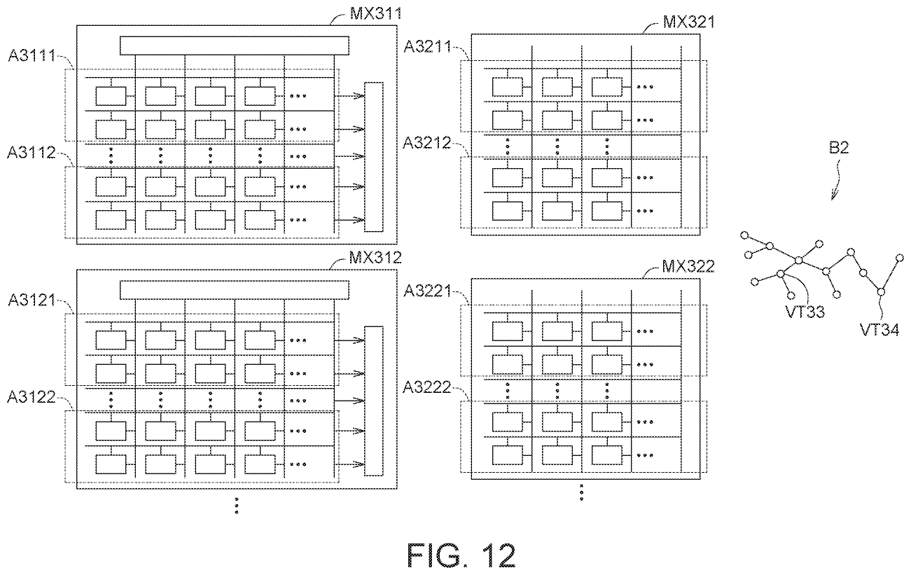

As shown in FIG. 12, for the batch B2, the memory area A3112 is used to store the edge list of the vertex VT33, and the memory area A3212 is used to store the features of the vertex VT33. The memory area A3122 is used to store the edge list of the vertex VT34, and the memory area A3222 is used to store the features of the vertex VT34.

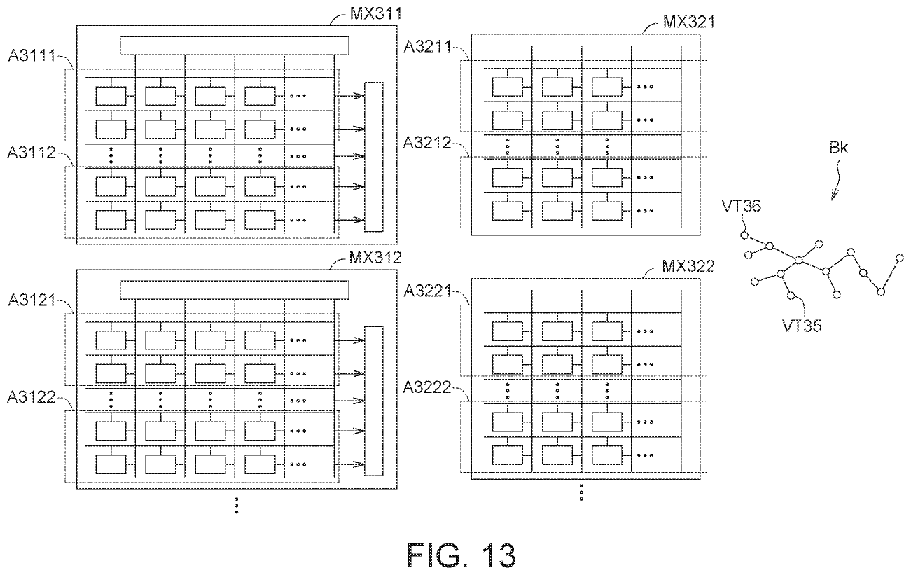

As shown in FIG. 13, for the batch Bk, the memory area A3111 is used to store the edge list of the vertex VT35, and the memory area A3211 is used to store the features of the vertex VT35. The memory area A3121 is used to store the edge list of the vertex VT36, and the memory area A3221 is used to store the features of the vertex VT36. That is to say, the same memory area can be reused for different vertexes. The memory can be efficiently utilized.

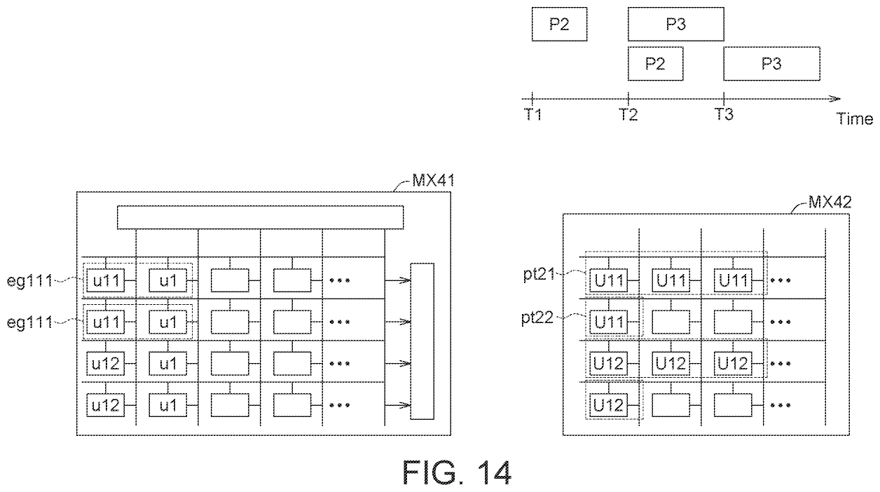

In one case, the column bandwidth of the MAC crossbar matrix may not enough for store the feature of one node or one vertex. To avoid speed downgrade, a pipeline operation can be applied here. Please refer to FIG. 14, which illustrates the pipeline operation in the TCAM-based data processing strategy. As shown in FIG. FIG. 14, the feature U11 is divided into two parts pt21, pt22 and stored in two rows. The edge eg111 is stored in two rows of the TCAM crossbar matrix MX41. The aggregations for the parts pt21, pt22 are independent. At the time T1, the aggregation phase P2 for the part pt21 is executed; at the time T2, the update phase P3 for the part pt21 can be started to be executed. At the time T2, the aggregation phase P2 for the part pt22 is executed; at the time T3, the update phase P3 for the part pt22 can be started to be executed.

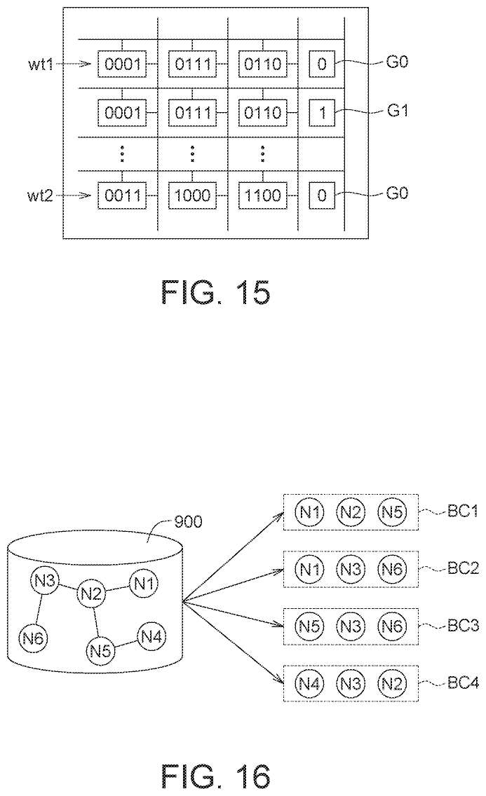

The dynamic fixed-point formatting approach is also applied in the aggregation phase P2. The weightings or the features stored in the crossbar matrix may have floating-point format. In the present technology, the weightings or the features can be stored in the crossbar matrix via a dynamic fixed-point format. Please refer to FIG. 15, which illustrates the dynamic fixed-point formatting approach. As shown in the following table I, the weightings can be represented as the floating-point format.

TABLE I

| weightings | floating-point format | mantissa | exponent |
|---|---|---|---|
| 0.2165 | 1.10111011 × 2\hat{ }-3 | 10111011 | 2\hat{ }-3 |
| 0.214 | 1.10110110 × 2\hat{ }-3 | 10110110 | 2\hat{ }-3 |
| 0.202 | 1.10011101 × 2\hat{ }-3 | 10011101 | 2\hat{ }-3 |
| 0.0096 | 1.00111010 × 2\hat{ }-7 | 00111010 | 2\hat{ }-7 |
| 0.472 | 1.11100011 × 2\hat{ }-2 | 11100011 | 2\hat{ }-2 |

The exponent range is from 2\hat{ }-0 to 2\hat{ }-7. In this embodiment, the exponent range can be classified into two groups G0, G1. The group G0 is from 2\hat{ }-0 to 2\hat{ }-3, and the group G1 is from 2\hat{ }-4 to 2\hat{ }-7. As shown in FIG. 15, if the exponent of the data is within the group G0, “0” is stored; if the exponent of the data is within the group G1, “1” is stored. For precisely representing “2-0”, the mantissa is shifted by 0 bit. For precisely representing “2\hat{ }-1”, the mantissa is shifted by 1 bit. For precisely representing “2\hat{ }-2”, the mantissa is shifted by 2 bits. For precisely representing “2\hat{ }-3”, the mantissa is shifted by 3 bits. For precisely representing “2\hat{ }-4”, the mantissa is shifted by 0 bit. For precisely representing “2\hat{ }-5”, the mantissa is shifted by 1 bit. For precisely representing “2\hat{ }-6”, the mantissa is shifted by 2 bits. For precisely representing “2\hat{ }-7”, the mantissa is shifted by 3 bits. For example, the weighting wt1 is “0.2165”, the mantissa “0.2165” is “10111011”, the last bit is “0” to represent the group G0, and the mantissa “10111011” is shifted by 3 bits to precisely representing “2\hat{ }-3.” The weighting wt2 is “0.472”, the mantissa “0.472” is “11100011”, the last bit is “0” to represent the group G0, and the mantissa “11100011” is shifted by 2 bits to precisely representing “2\hat{ }-2.”

According to the dynamic fixed-point formatting approach, the 7 exponents are classified into only two groups G0 and G1, so the computing cycle can be reduced from 7 to 2, the computing speed can be greatly increased.

Furthermore, the adaptive data reusing policy applied for the step S110 of sampling data from the dataset 900 is illustrated as below. The adaptive data reusing policy includes a bootstrapping approach, a graph partitioning approach and a non-uniform bootstrapping approach.

Please refer to FIG. 16, which illustrates the bootstrapping approach. Each of batches BC1, BC2, BC3, BC4 is used to execute one iteration. The batch BC1 includes the data of the nodes N1, N2, N5; the batch BC2 includes the data of the nodes N1, N3, N6; the batch BC3 includes the data of the nodes N5, N3, N6; the batch BC4 includes the data of the nodes N4, N3, N2. The data of the node N1 is repeated within the batches BC1 and the batch BC2. The data of the node N3 is repeated within the batches BC3 and the batch BC4.

According to the bootstrapping approach, some data is repeated within two batches, so the data movement can be greatly reduced. The training performance can be improved.

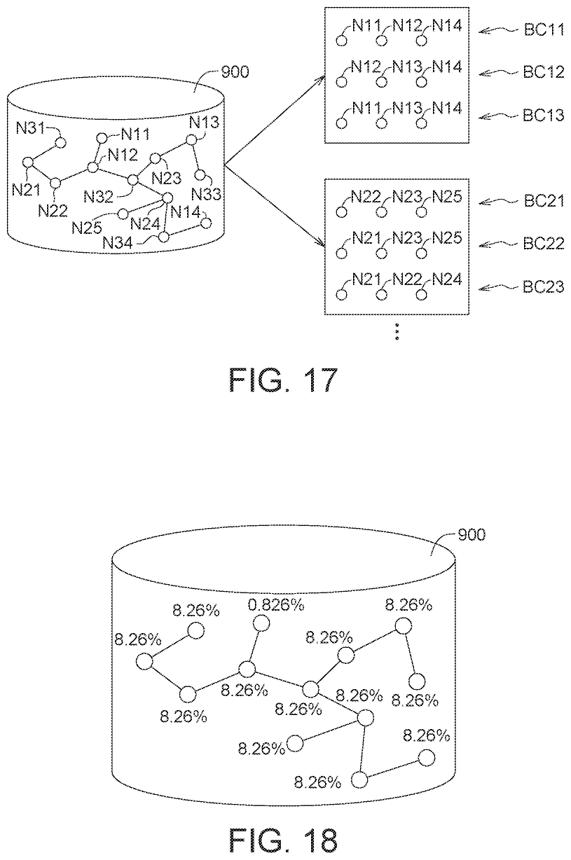

Please refer to FIG. 17, which illustrates the graph partitioning approach. In a graph, the graph size (number of all of the nodes) is n and the batch size (number of the nodes in one batch) is b. The reusing rate is b/n. If the reusing rate is too low, the bootstrapping approach may not cause a great improvement, the graph is needed to be partitioned for increasing the reusing rate. As shown in FIG. 17, the nodes in the graph are randomly segmented into 3 partitions. The reusing rate will be increased 3 times. The data of the nodes N11 to N14 are arranged in the batches BC11 to BC13. The data of the nodes N12, N14 are repeated within the batches BC11 and the batch BC12. The data of the nodes N13, N14 are repeated within the batches BC12 and the batch BC13.

The data of the nodes N21 to N25 are arranged in the batches BC21 to BC23. The data of the nodes N23, N25 are repeated within the batches BC21 and the batch BC22. The data of the node N21 is repeated within the batches BC22 and the batch BC23.

According to the graph partitioning approach, the reusing rate is increased and the bootstrapping approach still has a great improvement even if the graph is large.

Please refer to FIG. 18, which illustrates the non-uniform bootstrapping approach. In the bootstrapping approach, data of some of the nodes are repeatedly sampled, so some of the nodes may be sampled too much times and the accuracy may be affected. As shown in FIG. 18, sampling probabilities of the nodes are non-uniform. After some times of iteration, the sampling times of the node N8 is above out of a boundary, so the sampling probability of the node N8 is reduced to be 0.826% which is lower than the sampling probability of the other nodes.

According to the non-uniform bootstrapping approach, any node may not be sampled too much times and the accuracy can be kept.

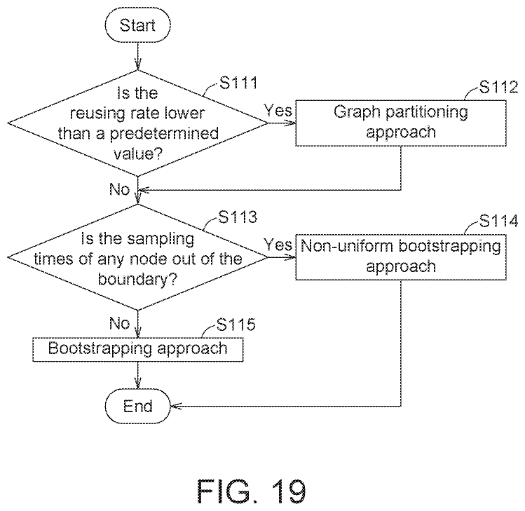

The adaptive data reusing policy including the bootstrapping approach, the graph partitioning approach and the non-uniform bootstrapping approach can be executed via the following flowchart. Please refer to FIG. 19, which shows a flowchart of the adaptive data reusing policy according to one embodiment. In step S111, whether the reusing rate is lower than a predetermined value is determined. If the reusing rate is lower than the predetermined value, then the process proceeds to step S112; if the reusing rate is not lower than the predetermined value, then the process proceeds to step S113.

In the step S112, the graph partitioning approach is executed.

In the step S113, whether the sampling time of any node is out of the boundary is determined. If the sampling time of any node is out of the boundary, the process proceeds to step S114; if the sampling times of all of the nodes are not out of the boundary, the process proceeds to step S115.

In the step S114, the non-uniform bootstrapping approach is executed.

In the step S115, the (uniform) bootstrapping approach executed.

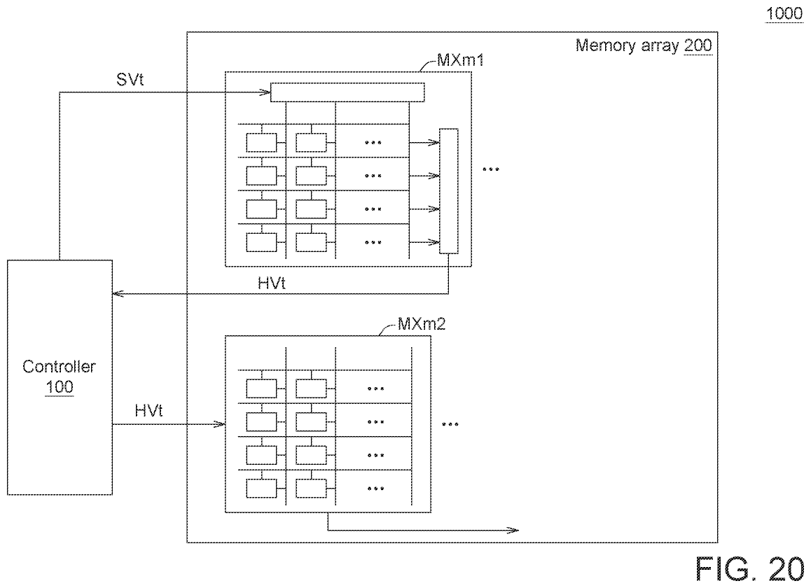

Moreover, please refer to FIG. 20, which shows a memory device 1000 adopted the training method described above. The memory device 1000 includes a controller 100 and a memory array 200. The memory array 200 is connected to the controller 100. The memory array 200 includes at least one TCAM crossbar matrix MXm1 and at least one MAC crossbar matrix MXm2. The TCAM crossbar matrix MXm1 stores the edges egij corresponding to one vertex. The TCAM crossbar matrix MXm1 receives a search vector SVt, and then outputs a hit vector HVt for selecting some of the edges egij. The MAC crossbar matrix MXm2 stores a plurality of features in the edges egij for performing the multiply accumulate operation according to the hit vector HVt.

According to the embodiments described above, in the TCAM-based training method for Graph Neural Network, the adaptive data reusing policy is applied in the sampling step (step S110), and the TCAM-based data processing strategy and the dynamic fixed-point formatting approach are applied in the aggregation phase P2. The data movement can be greatly reduced and accuracy can be kept. The training efficiency of the in-memory computing, especially for the Graph Neural Network, is greatly improved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A Ternary Content Addressable Memory (TCAM)-based training method for Graph Neural Network, comprising:
sampling data from a dataset; and
training the Graph Neural Network according to the data from the dataset, wherein the step of training the Graph Neural Network includes:
a feature extraction phase;
an aggregation phase; and
an update phase;
wherein in the aggregation phase, one TCAM crossbar matrix stores a plurality of edges corresponding to one vertex and outputs a hit vector for selecting some of the edges, and a Multiply Accumulate (MAC) crossbar matrix stores a plurality of features in the edges for performing a multiply accumulate operation according to the hit vector.

2. The TCAM-based training method for the Graph Neural Network according to claim 1, wherein the TCAM crossbar matrix stores a source node and a destination node of each of the edges.

3. The TCAM-based training method for the Graph Neural Network according to claim 2, wherein the TCAM crossbar matrix further stores a layer of each of the edges.

4. The TCAM-based training method for the Graph Neural Network according to claim 2, wherein the TCAM crossbar matrix further stores a plurality of edges corresponding to another one vertex.

5. The TCAM-based training method for the Graph Neural Network according to claim 1, wherein one of the features is stored in two rows of the MAC crossbar matrix, and the aggregation phase and the update phase are executed via pipeline.

6. The TCAM-based training method for the Graph Neural Network according to claim 1, wherein each of the features or each of a plurality of weightings has a mantissa and an exponent, each of the exponents is classified into one of two groups, and each of the mantissas is shifted according to each of the exponents.

7. The TCAM-based training method for the Graph Neural Network according to claim 1, wherein in the step of sampling the data from the dataset, data of at least one node is repeated within two batches.

8. The TCAM-based training method for the Graph Neural Network according to claim 1, wherein in the step of sampling the data from the dataset, a graph is segmented into more than one partitions.

9. The TCAM-based training method for the Graph Neural Network according to claim 1, wherein in the step of sampling the data from the dataset, a plurality of sampling probabilities of a plurality of nodes are non-uniform.

10. The TCAM-based training method for the Graph Neural Network according to claim 9, wherein in the step of sampling the data from the dataset, the sampling probability of one of the nodes whose sampling times is out of a boundary is reduced.

11. A memory device, comprising:
a controller, and
a memory array, connected to the controller, wherein in the memory array, one Ternary Content Addressable Memory (TCAM) crossbar matrix stores a plurality of edges corresponding to one vertex and outputs a hit vector for selecting some of the edges, and a Multiply Accumulate (MAC) crossbar matrix stores a plurality of features in the edges for performing a multiply accumulate operation according to the hit vector.

12. The memory device according to claim 11, wherein the TCAM crossbar matrix stores a source node and a destination node of each of the edges.

13. The memory device according to claim 12, wherein the TCAM crossbar matrix further stores a layer of each of the edges.

14. The memory device according to claim 12, wherein the TCAM crossbar matrix further stores a plurality of edges corresponding to another one vertex.

15. The memory device according to claim 11, wherein one of the features is stored in two rows of the MAC crossbar matrix, and the controller is configured to execute an aggregation phase and an update phase via pipeline.

16. The memory device according to claim 11, wherein each of the features or each of a plurality of weightings has a mantissa and an exponent, each of the exponents is classified into one of two groups, and each of the mantissas is shifted according to each of the exponents.

17. The memory device according to claim 11, wherein the controller is configured to repeatedly sample data of at least one node within two batches.

18. The memory device according to claim 11, wherein the controller is configured to sample data from a dataset, and segment a graph into more than one partitions.

19. The memory device according to claim 11, wherein the controller is configured to sample data from a dataset, and control a plurality of sampling probabilities of a plurality of nodes being non-uniform.

20. The memory device according to claim 19, wherein the controller is further configured to reduce the sampling probability of one of the nodes whose sampling times is out of a boundary.
